(19) United States
(12) Patent Application Publication
(10) Pub. No.: US 2020/0315184 A1
(43) Pub. Date: Oct. 8, 2020

(54) COMPOSITIONS AND METHODS FOR DETERRING THE PRESENCE OF BEES AND OTHER INSECTS

(71) Applicant: Rachna Nath, Chandler, AZ (US)

(72) Inventor: Rachna Nath, Chandler, AZ (US)

(21) Appl. No.: 16/908,684

(22) Filed: Jun. 22, 2020

Related U.S. Application Data
(62) Division of application No. 15/927,257, filed on Mar. 21, 2018.
(60) Provisional application No. 62/480,296, filed on Mar. 31, 2017.

(51) Int. Cl. A01N 65/42; A01M 1/20; A01N 65/24; A01N 65/28; A01N 31/02; A01N 65/22

(52) U.S. Cl. CPC A01N 65/42; A01M 1/2055; A01N 65/24; A01M 2200/012; A01N 31/02; A01N 65/22; A01N 65/28

(57) ABSTRACT

Provided herein are compositions and methods for repelling insects, such as bees. The compositions include herbs and can also include essential oil. The herbs can include garlic, cinnamon, black pepper, or mint, such as peppermint. The essential oils can include eucalyptus oil, cinnamon oil, cardamom oil and tea tree oil. Also provided are articles that include the compositions. Bees can be repelled without negatively impacting swarming behavior or hive health.

### RELATED PATENT APPLICATION(S)

This application claims the benefit of U.S. Provisional Application Ser. No. 62/480,296, filed Mar. 31, 2017 and entitled “Compositions and Methods for Deterring the Presence of Bees and Other Insects”, designated by Attorney Docket No. RACHNANATHPROV001. The entire contents of which is incorporated herein by reference, including all text, tables and drawings.

### FIELD

The invention relates generally to deterring but not killing annoying insects, and more specifically to non-toxic compositions and their uses to deter the presence of insects such as bees from swarming and or nesting in areas where their presence can be a nuisance or danger to humans, pets or livestock.

### BACKGROUND

When insects nest or swarm in areas heavily populated with humans, pets or livestock, the mere large presence can pose as a nuisance at best and aggravated swarms of insects can result in injury and possibly death at worse.

Generally, toxic insecticides designed to eradicate the insects via poisoning or sterilization are used to prevent swarming or nesting. These toxic methods also typically have collateral damage effects to other organisms, insects, humans and animals that may come in to contact with the insecticide/pesticide. In addition, products can claim to be non-toxic to other vertebrates and invertebrates but may still be dangerous. Most of the organophosphates, chlorinated hydrocarbons, carbonate compounds, and also botanical compounds like pyrethrin and nicotine have been seen to have harmful effects on human and other living organisms. (Mayer et al. 1999, Baker Et al. 1992, Taracad et al. 2010, Atkins et al 1997 and others). Other insect control solutions such as traps or baits can negatively impact beneficial insect populations.

Additionally, there are instances where the swarming insects may be a nuisance in one area but the insects also serve a vital part of the ecosystem thus, an ideal solution would be for the swarm to move on to a more ideal location away from humans/livestock/pets. Thus, there are plenty of instances where it is ideal not to kill or sterilize the swarm but rather to persuade the swarm to move to a more remote location.

In the case of bees, they have been known to swarm and nest in homes in and around eaves, roofing tiles, and even within the walls. When this happens there is an extensive and expensive process of either fumigating them out and killing them or having a beekeeper smoke them out and move the queen. These methods are generally messy, time consuming and expensive. A swarm removal on average costs around $200. If the swarm makes a hive inside a commercial location, that price can increase thousands of dollars.

Another risk is getting stung by a bee or bees from the swarm and potentially severe complications. This burdens medical insurance companies relating to deaths and severe allergic reactions to bee stings.

It is not always ideal to terminate nuisance insects because many serve vital roles in our ecosystem. For example, bees have been dying at a tremendous rate especially during swarming season due to the over use of pesticides and insecticides. Three fourths of the world's food comes from pollinators. Bees are the principal pollinators of the world's food resources. It is a global problem that requires vigilance.

Until now this problem has not been adequately addressed, thus a need exists for an environmentally friendly and honey bee/other household pest friendly methods and compositions for deterring but not killing the helpful insects.

### SUMMARY

Provided herein are compositions useful for deterring swarming insects comprising garlic and cinnamon in a mixture with an essential oil. In some embodiments, provided are compositions that further include black pepper and/or mint, such as peppermint. In some embodiments, the essential oil includes eucalyptus oil or tea tree oil. In some embodiments, the composition further includes alcohol, such as isopropyl alcohol. The provided compositions, in some embodiments, does not harm the insect. The provided compositions, in some embodiments, are edible. The provided compositions, in some embodiments, do not include toxic insecticide.

Also provided herein are articles that include the above compositions and methods for repelling or directing an insect away from a structure, article and/or organisms by applying the above compositions to the structure, article and/or organism.

Certain embodiments are described further in the following description, examples, and claims.

### DETAILED DESCRIPTION

Provided herein are compositions and methods for deterring swarming insects, such as bees, from inhabiting certain areas cheaply and easily without killing the insects. Compositions and methods provided herein can potentially reduce swarms of honey bees being killed during swarming. The provided compositions and methods may be used as a deterrent of water forager (bees that collect water) coming to backyard swimming pools and other pests like common houseflies, scorpions, ants, mosquitoes and crickets.

Swarms occur when a hive becomes overcrowded and the queen takes off from the original hive with 30-35% of the hive to look for a new place to live. At this point, the swarm is not very far from the original hive but then scout bees are sent out to search for locations that are congenial for the whole swarm to move in.

While not wishing to be bound by theory, it is believed that if the scout bees are deterred from a location, the swarm will not relocate to the location and the burden of removing the swarm from a location can be reduced or eliminated. Such a result provides financial benefit to the public as well as saving bees from being killed using insecticides.

In an aspect, the insect can be a pollinating insect. In another aspect, the insect is a repelled, controlled, or directed non-pollinating insect.

In an aspect, the insect is of the order Order Hymenoptera. In yet another aspect, the insect is a bee. In another aspect, the bee is a honey bee (Apis). In another aspect, the bee is a European honey bee (Apis mellifera) or Africanized honey bee. Examples of common bees are bumble bees (Bombus), small carpenter bees (Ceratina), large carpenter bees (Xylocopa), paper wasps (Polistes), yellow jackets (Vespula), and baldfaced hornets (Vespula). As used herein, the term “honey bee” can refer to any member of the Order Hymenoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In yet another aspect, the insect is a butterfly. Butterflies are insects of the Order Lepidoptera. In an aspect, a butterfly is a true butterfly (superfamily Papilionoidea), a skipper (superfamily Hesperioidea), or a moth-butterflies (superfamily Hedyloidea). Examples of common butterflies are Swallowtails and Birdwings (Family Papilionidae) such as Common Yellow Swallowtail (Papilio machaon), Spicebush Swallowtail (Papilio Troilus), Lime Butterfly (Papilio demoleus), the Ornithoptera genus, the Whites and Yellows (Family Pieridae), such as Small White (Pieris rapae), Green-veined White (Pieris napi), Common Jezebel (Delias eucharis), the Blues and Coppers or Gossamer-Winged Butterflies (Family Lycaenidae) such as Red Pierrot (Talicada nyseus), Metalmark butterflies (Family Riodimidae) such as Duke of Burgundy (Hamearis lucina), Plum Judy, (Abisara echerius), the Brush-footed butterflies (Family Nymphalidae) such as Painted Lady, or Cosmopolitan (Vanessa cardui), Monarch butterfly (Danaus plexippus), Morpho genus, Speckled Wood (Pararge aegeria), Skippers (Family Hesperiidae) such as Mallow Skipper (Carcharodus alceae), and Zabulon Skipper (Poanes zabulon).

In another aspect, an insect described herein is an ant. In yet another aspect, the ant is a carpenter ant, a fire ant, a pharaoh ant, a ghost ant, and a black ant. In another aspect, the insect is a common housefly, mosquito or cricket.

In another aspect, compound or composition described herein selectively repels any of the insects described herein. In another aspect, a compound or composition described herein selectively repels some insects, but not others.

Provided herein are compositions that include herbs and essential oils that repel bees and other insects. Herbs and essential oils can include: mint, such as peppermint, garlic, cinnamon, black pepper, eucalyptus oil, tea tree oil, cinnamon oil, and cardamom oil.

In some embodiments, the composition includes garlic and cinnamon. In some embodiments, the garlic:cinnamon ratio is about 5:2 (g/g), where the components are weighed in grams. In some embodiments, the ratio of garlic:cinnamon is in a range of 10-25:4-7 (g/g). In some embodiments, the ratio of garlic:cinnamon is in a range of 5-50:1-15. In some embodiments, the composition includes garlic, cinnamon and an essential oil. In some embodiments, the garlic:cinnamon:essential oil ratio is about 5:2:26 (g/g/ml), where garlic and cinnamon are weighed in grams and essential oil is measured in milliliters. In some embodiments, the ratio of garlic:cinnamon:essential oil is in a range of 10-25:4-7:50-120 (g/g/ml). In some embodiments, the ratio of garlic:cinnamon:essential oil is in a range of 5-50:1-15:20-200 (g/g/ml). The essential oil can be tea tree oil, cinnamon oil, or eucalyptus oil.

In some embodiments, the composition includes garlic, cinnamon and black pepper. In some embodiments, the garlic:cinnamon:black pepper ratio is about 5:2:0.2 (g/g/g), where the components are weighed in grams. In some embodiments, the ratio of garlic:cinnamon:black pepper is in a range of 10-25:4-7:0.21-0.5 (g/g/g). In some embodiments, the ratio of garlic:cinnamon:black pepper is in a range of 5-50:1-15:0.1-1.0 (g/g/g). In some embodiments, the composition includes garlic, cinnamon, black pepper and essential oil. In some embodiments, the garlic:cinnamon:black pepper:essential oil ratio is about 5:2:0.2:26 (g/g/g/ml). In some embodiments, the ratio of garlic:cinnamon:black pepper:essential oil is in a range of 10-25:4-7:0.1-0.5:50-120 (g/g/g/ml). In some embodiments, the ratio of garlic:cinnamon:black pepper:essential oil is in a range of 5-50:1-15:0.1-1.0:20-200 (g/g/g/ml).

In some embodiments, the composition includes garlic, cinnamon, and mint. In some embodiments, the garlic:cinnamon:mint ratio is about 5:2:0.3 (g/g/g), where the components are weighed in grams. In some embodiments, the ratio of garlic:cinnamon:mint is in a range of 10-25:4-7:0.3-0.6 (g/g/g). In some embodiments, the ratio of garlic:cinnamon:mint is in a range of 5-50:1-15:0.1-1.0 (g/g/g). In some embodiments, the composition includes garlic, cinnamon, mint and essential oil. In some embodiments, the garlic:cinnamon:mint:essential oil ratio is about 5:2:0.3:26 (g/g/g/ml). In some embodiments, the ratio of garlic:cinnamon:mint:essential oil is in a range of 10-25:4-7:0.3-0.6:50-120 (g/g/g/ml). In some embodiments, the ratio of garlic:cinnamon:mint:essential oil is in a range of 5-50:1-15:0.1-1.0:20-200 (g/g/g/ml).

In some embodiments, the composition includes, mint, garlic, black pepper and cinnamon. In some embodiments, the garlic:cinnamon:mint:black pepper ratio is about 5:2:0.32:0.2 (g/g/g/g), where the components are weighed in grams. In some embodiments, the ratio of garlic:cinnamon:mint:black pepper is in a range of 10-25:4-7:0.3-0.6:0.2-0.6 (g/g/g/g). In some embodiments, the ratio of garlic:cinnamon:mint:black pepper is in a range of 5-50:1-15:0.1-1.:01-1.0. In some embodiments, the composition includes garlic, cinnamon, mint, black pepper and essential oil. In some embodiments, the garlic:cinnamon:mint:black pepper:essential oil ratio is about 5:2:0.3:0.2:26 (g/g/g/g/ml). In some embodiments, the ratio of garlic:cinnamon:mint:black pepper:essential oil is in a range of 10-25:4-7:0.3-0.6:0.2-0.6:50-120 (g/g/g/g/ml). In some embodiments, the ratio of garlic:cinnamon:mint:black pepper:essential oil is in a range of 5-50:1-15:0.1-1.0:0.1-1.0:20-200 (g/g/g/g/ml).

In some embodiments, the composition includes black pepper, cinnamon and eucalyptus oil. The relevant proportions are provided above.

In some embodiments, any of the compositions above further includes an alcohol. In some embodiments the alcohol is isopropyl alcohol. In some embodiments the alcohol is 70% isopropyl alcohol.

In some embodiments, the compositions and methods do not harm the insect. As used herein, “does not harm the insect” means that the compositions and methods repel the insect, but do not exert toxic or other injurious effects to the insect (such as impacting growth). In some embodiments, the compositions and methods do not contribute to bee colony collapse. In some embodiments, the composition is edible by a mammal. In some embodiments, the compositions and methods do not include a compound harmful to mammals.

In an aspect, a composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In another aspect, a compound or composition described herein repels, controls, or directs an insect of interest such that the insect is not in direct contact for at least about 10 minutes, about 20 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more with a treated substance, such as a structure, article, or organism. In yet another aspect, a compound or composition described herein repels, controls, or directs an insect of interest such that the insect is not in direct contact with a treated substance for a specified time, for example, a planting, growing, or harvesting season.

In another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a treated substance, such as a structure, article, or organism.

In yet another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a treated substance, such as a structure, article, or organism, for at least about 10 minutes, about 20 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or a designated time frame, or growing season.

In another aspect, a compound or composition described herein controls or directs an insect of interest, such as a bee, for at least about 10 minutes, about 20 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, about 3 months or more, or a designated time frame or growing or harvesting season.

A compound or composition described herein can also be formulated in a delayed release formulation or controlled release formulation which can delay or control the release of the repellent compound or composition. In another aspect, a compound or composition described herein can also be formulated in a rapid release formulation which can expedite the release of the repellent compound or composition.

In an aspect, a method of “repelling” refers to the ability of a composition described herein to influence or alter the behavior of an insect, for example, a bee, away from an area, location, structure, article, or substance of interest. In order to be classified as “repelling” according to an aspect of the disclosure, it is not necessary that 100% of the insects be directed away from an area, mammal, location, structure, article, or substance of interest. In yet another aspect, an insect is “repelled” if at least 50%, at least 75%, at least 90%, at least 95%, or at least 98% of the insects are directed away from an area, organism, location, structure, article, or substance of interest.

In another aspect, a method of “directing” refers to the ability of a compound or composition described herein to influence the behavior or movement of an insect, for example a bee, in a given direction. In order to be classified as “directing” according to an aspect of the disclosure, it is not necessary that 100% of the insects be directed away from an area, mammal, location, structure, article, or substance of interest. In yet another aspect, an insect is “directed away” if at least 50%, at least 75%, at least 90%, at least 95%, or at least 98% of the insects are directed away from an area, organism, location, structure, article, or substance of interest.

In an aspect, a method of “controlling” refers to the ability of a compound or composition described herein to control or alter the behavior of an insect, for example a bee. In order to be classified as “controlling” according to an aspect of the disclosure, it is not necessary that 100% of the insects are controlled relative to an area, mammal, location, structure, article, or substance of interest. In yet another aspect, an insect is “controlled” if at least 50%, at least 90%, at least 95%, or at least 98% of the insect behavior is altered or controlled relative to an area, mammal, location, structure, article, or substance of interest.

In an aspect, a compound or composition described herein has the ability to repel or direct an insect away from a structure. Without being limited, a “structure” is an area or locus capable of contacting or being infested by an insect. In another aspect, a “structure” can be man-made or naturally occurring. Without being limited, a “structure” can be a building, for example a commercial or residential building, the interior or exterior of a building, an outdoor space, including but not limited to a field, a park area, a golf course or the like, a car, a boat, a patio, a deck, a table, a chair, a window, a container, a container designed to hold an insect, a container designed to repel, direct, or control an insect, a trashcan or a trash receptacle, an indoor space, such as a room in a commercial or residential building, an outdoor space, or structures oftentimes present in an outdoor space, such as a tree, a bush, a clover, a shrub, a flowering plant, a lawn, a shed, or other such structure.

In an aspect, a compound or composition described herein has the ability to repel or direct an insect away from an article. Without being limited, an “article” is an element that is capable of being contacted, influenced, or infested by an insect. In another aspect, without being limited, an “article” can be bait, a bait mechanism or holder, a device, garment, belt, air freshener, candle, other scented article, fiber, bedding, sheet, cloth, clothing, net, insect netting, fabric, paper, glass, paint, ink, clay, cotton, woods, furniture, carpet, sanitary good, plastic, polymer, biological or synthetic material, spray product, fogging system, fogger, foam, gel, evaporator product, evaporator system, granule, or dust.

In another aspect, an article may be treated, coated, sprayed with, or impregnated with a compound or composition described herein.

In an aspect, an organism is an animal or a human. In another aspect, a compound or composition described herein has the ability to repel or direct an insect away from an organism, for example, an animal or a human. In another aspect, a compound or composition described herein has the ability to control the behavior of insects in areas containing animals or a human. In an aspect, a compound or composition described herein can be utilized in any application that reduces bee-human interaction or a bee-location interaction. In another aspect, a compound or composition described herein may be administered to an individual or location alone, or in combination with other supplementary active ingredient, agent, or drug.

In another aspect, livestock can be treated with an insect repellent, controlling, or directing compound or composition described herein. In an aspect and without being limited, a compound or composition described herein can be used to repel, control, or direct insects in contact with or close to livestock. In another aspect, “livestock” can include any animal capable of being infested by an insect, for example, cattle, sheep, goats, horses, pigs, rabbits, chickens, turkeys, ducks, geese, and domestic animals, such as dogs, cats, caged birds, hamsters, guinea pigs, rats, and mice.

Compounds and compositions described herein may be formulated and packaged so as to deliver the product in a variety of forms including as a solution, suspension, cream, ointment, gel, film or spray, depending on the preferred method of use.

In a non-limiting aspect, compositions according to the disclosure may be formulated and used in various forms, such as aerosol dispenser, bait (ready for use), bait concentrate, block bait, capsule suspension, cold fogging concentrate, dust able powder, emulsifiable concentrate, emulsion oil in water, emulsion water in oil, encapsulated granule, fine granule, grain bait, granular bait, granule, macro granule, micro granule, oil dispersible powder, oil miscible flow able concentrate, oil miscible liquid, paste, plate bait, scrap bait, smoke candle, smoke cartridge, smoke generator, smoke pellet, smoke rodlet, smoke tablet, smoke tin, soluble concentrate, soluble powder, suspension concentrate, oil dispersible or suspension in oil, tracking powder, ultra-low volume (ulv) liquid, ultra-low volume (ulv) suspension, vapor releasing product, water dispersible granules or tablets, water dispersible powder for slurry treatment, water soluble granules or tablets, or water soluble powder for seed treatment and wettable powder or any other forms of slow release/controlled release formulations.

In another aspect, a compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, soluble concentrates, suspensions, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

In another aspect, a compound or composition described herein is formulated as a topical composition, for example, cologne, sunscreen, lotion, spray, cream, gel, ointment, foam product, soap composition, for example, hand soap and bath/shower soap. In an aspect, desirable properties of a topical insect repellent article include low toxicity, resistance to loss by water immersion or sweating, low or no odor, ease of application, rapid formation of a dry tack-free surface film on the host's skin. In another aspect, a compound or composition described herein is designed to disperse the article into the air or disperse a compound or composition as a liquid mist or fine dust. Additionally, directly spreading of the liquid/semi-solid/solid repellent article on the host is an effective method of contacting the surface of the host with an effective amount of the repellent composition.

In another aspect, a compound or composition disclosed herein may optionally include one or more additional compounds providing an additional beneficial or otherwise useful effect. Such compounds include, without limitation, an adhesive, a solvent, a wetting agent, an emulsifying agent, a carrier, an adjuvant, a diluent, a dispersing agent, a fertilizer of a micronutrient or macronutrient nature, a herbicide, a feeding inhibitor, an insect molting inhibitor, an insect mating inhibitor, an insect maturation inhibitor, a nematocide, a nutritional or horticultural supplement, or any combination thereof.

In another aspect, compounds or compositions described herein can be combined with a fertilizer. Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, nitrate of potash, Potassium Chloride, muriate of potash, di and mono potassium salts of phosphite/phosphonate.

The following examples are intended to illustrate but not limit the invention.

### EXAMPLES

The examples set forth below illustrate certain embodiments and do not limit the technology.

### Example 1

### Bee Repellent Compositions Reduce Forager Bee Encounters

This example illustrates the use of various embodied compositions and determining the effectiveness of the deterrence in public settings.

Mixtures of different proportions of garlic, cinnamon, mint, black pepper and eucalyptus oil were prepared. Garlic (cloves) (Kroger, Cincinatti, Ohio), cinnamon (stick) (B&G Foods, Inc., Parsippany, N.J.), peppermint (garden grown), and black pepper (Kroger, Cincinatti, Ohio) were combined in the proportions as shown in Table 1 and crushed using mortar and pestle. Eucalyptus oil (Ashwin Pharma, Kashi Village Dist. Thane-401104, India) and 70% alcohol (Cumberland-Swan, Inc., Smyrna, Tenn.), were mixed with the crushed herbs.

The composition was placed in and around flower bushes at Tumbleweed Park in Chandler Arizona where bees were known to forage continuously during the day. The bees did not come to forage around those bushes where the compositions were placed. This experiment was repeated several times over a period of 4 months. Mostly sunny days were chosen and the experiments were performed around 11 am where maximum foraging activity is observed. The experiment was also attempted during evening hours but the overall lack of foraging activity did not allow an accurate evaluation of the effectiveness of the compositions.

Table 1 shows the concentration and the time lapse between the forager bees return. The time lapse of forager bee return in the absence of the composition was zero.

TABLE 1

| | | Peppermint | | Black | | | |
|---|---|---|---|---|---|---|---|
| | Cloves of | Leaves | Cinnamon | pepper | Eucalyptus | 70% | Time |
| | Garlic (g) | with stem (g) | Sticks (g) | whole (g) | oil (ml) | Alcohol (ml) | lapsed |
| Mixture A | 5 (26.05) | 15 (1.7) | 4 (8.48) | 10(0.6) | 148 | 30 | 20 |
| Mixture B | 6 (35.11) | 20 (2.1) | 5 (11.41) | 15(1.1) | 118 | 30 | 24 |
| Mixture C | 6 (35.11) | 25 (2.6) | 6 (13.78) | 15(1.1) | 177 | 30 | 22 |
| Mixture D | 6 (35.11) | 30 (3.15) | 3 (6.82) | 15(1.1) | 207 | 30 | 25 |

As shown in the Table above, the tested compositions directed bee behavior between at least 20 and 25 minutes.

### Example 2

### Bee Repellent Compositions Increase Distance of Bee From Repellent Source

In separate determinations, each of tea tree oil, cinnamon oil and eucalyptus oil was placed on a cotton face cleaning pad and put inside a Mason jar on the bottom with a distance measuring scale by its side measuring from the bottom to the top of the jar. A bee collected from the surrounding area was introduced into the jar and the lid was placed on top. The bees were repelled by each of the oils as they were seen to hover around the top of the jar as far from the oil as possible. The control with no oil, showed no such behavior, the bee was as likely to hover low in the jar or even land on the bottom surface as it was to hover at the top of the jar. The experiment was repeated multiple times for multiple bees. The results demonstrate that the bees are repelled by the tee tree oil the most in comparison to Eucalyptus and cinnamon oil.

In other experiments, the oil was placed directly on the bottom surface of the mason jar and a bee introduced. The bees that came in contact with the tea tree oil or eucalyptus oil died, thus demonstrating that it is necessary to provide a contact barrier between the bees and the tea tree oil or eucalyptus oil in order to prevent the bees from injury. This could be accomplished by any physical separation barrier such as a screen or a cage to contain an oil-containing object (such as a cotton face cleaning pad).

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Their citation is not an indication of a search for relevant disclosures. All statements regarding the date(s) or contents of the documents is based on available information and is not an admission as to their accuracy or correctness.

Modifications may be made to the foregoing without departing from the basic aspects of the technology. Although the technology has been described in substantial detail with reference to one or more specific embodiments, those of ordinary skill in the art will recognize that changes may be made to the embodiments specifically disclosed in this application, yet these modifications and improvements are within the scope and spirit of the technology.

The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present technology has been specifically disclosed by representative embodiments and optional features, modification and variation of the concepts herein disclosed may be resorted to by those skilled in the art, and such modifications and variations are considered within the scope of this technology. Certain embodiments of the technology are set forth in the claim(s) that follow(s).

What is claimed is:

1-20. (canceled)

21. A method of repelling an insect from a structure, article, and/or organism, the method comprising applying a composition comprising black pepper and tea tree oil to the structure, article, or organism.

22. The method of claim 21, wherein the composition is applied to an article that is a bait mechanism, bait holder, garment, belt, candle, fiber, bedding, sheet, cloth, clothing, net, insect netting, fabric, paper, glass, furniture, carpet, sanitary good, plastic, or polymer.

23. The method of claim 21, wherein the composition is applied to a structure that is a building, a field, a park area, a golf course, a car, a boat, a patio, a deck, a table, a chair, a window, a container, a trashcan, a trash receptacle, a room in a commercial or residential building, a tree, a bush, a clover, a shrub, a flowering plant, a lawn, or a shed.

24. The method of claim 21, wherein the composition is applied to an organism that is a human.

25. The method of claim 21, wherein the composition is applied to an organism that is livestock.

26. The method of claim 21, wherein the composition is formulated as a solution, suspension, cream, ointment, gel, film or spray.

27. The method of claim 21, wherein the composition is formulated as a topical composition.

28. The method of claim 21, wherein the insect is a swarming insect.

29. The method of claim 28, wherein the swarming insect is a bee.

30. The method of claim 21, wherein the composition further comprises garlic.

31. The method of claim 30, wherein the garlic is crushed.

32. The method of claim 21, wherein the composition further comprises cinnamon.

33. The method of claim 21, wherein the composition further comprises peppermint.

34. The method of claim 21, wherein the composition further comprises alcohol.

35. The method of claim 34, wherein the alcohol is isopropyl alcohol.

36. The method of claim 21, wherein the composition further comprises an adhesive, a solvent, a wetting agent, an emulsifying agent, a carrier, an adjuvant, a diluent, a dispersing agent, a fertilizer, a herbicide, a feeding inhibitor, an insect moulting inhibitor, an insect mating inhibitor, an insect maturation inhibitor, a nematicide, a nutritional supplement and/or a horticultural supplement.

37. The method of claim 21, wherein the composition is crushed.

38. The method of claim 21, wherein the composition does not kill the insect.

39. The method of claim 21, wherein the composition is edible by a mammal.

40. The method of claim 21, wherein the composition does not comprise a taxic insecticide.
